(19) United States
(12) Patent Application Publication
(10) Pub. No.: US 2014/0176774 A1
(43) Pub. Date: Jun. 26, 2014

(54) PHOTOGRAPHING APPARATUS AND METHOD FOR PHOTOGRAPHING IN AN APPROPRIATE PHOTOGRAPHING MODE

(71) Applicant: Samsung Electronics Co., Ltd., Suwon-si (KR)

(72) Inventor: Yasuhiro Morimoto, Yokohama (JP)

(73) Assignee: Samsung Electronics Co., Ltd., Suwon-si (KR)

(21) Appl. No.: 14/102,711

(22) Filed: Dec. 11, 2013

(30) Foreign Application Priority Data
Dec. 25, 2012 (JP) 2012-281270
Aug. 1, 2013 (KR) 10-2013-0091583

(51) Int. Cl. H04N 5/232

(52) U.S. Cl. CPC H04N 5/23222; H04N 5/23245; H04N 5/23293
USPC 348/333.04; 348/207.99

(57) ABSTRACT

A photographing apparatus and method for photographing in an appropriate photographing mode are described. In one implementation, the photographing apparatus includes a state determination unit that determines a state of a subject; a mode determination unit that determines a photographing mode according to the determined state of the subject; and a photography unit that carries out photography in the determined photographing mode.

### RELATED APPLICATIONS

This application claims the priority benefit under 35 U.S.C. §119(a) from Japanese Patent Application No. 2012-281270, filed on Dec. 25, 2012, in the Japanese Intellectual Property Office, and from Korean Patent Application No. 10-2013-0091583, filed on Aug. 1, 2013, in the Korean Intellectual Property Office, the disclosures of which are incorporated herein by reference in their entirety.

### BACKGROUND

1. Field

One or more embodiments relate to a photographing apparatus and method for photographing in an appropriate photographing mode.

2. Description of the Related Art

Photographing apparatuses, such as digital cameras, are becoming increasingly multi-functional. For example, a digital camera may include a single shooting mode, in which the camera photographs once when a shutter button is pressed, and a continuous shooting mode, in which the camera sequentially photographs multiple times.

In general, the single shooting mode is used by users to reduce mistakes caused due to hand trembling or a shaking subject, or to not miss a momentary opportunity for photography. Accordingly, the single shooting mode is a convenient mode for users.

However, in cameras according to the related art, the user has to manually change the single shooting mode and the continuous shooting mode. Therefore, the user may be confused as to the current mode when he presses the shutter button.

For example, the user may press the shutter button thinking that the camera is in the single shooting mode, but carry out photography in the continuous shooting mode. Therefore, although inconvenient, the user has to cautiously check settings of the camera before photographing so as to prevent unnecessary photography.

Also, the user may press the shutter button thinking that the camera is in the continuous shooting mode, but carry out photography in the single shooting mode. In this case, the user is only able to photograph once, and misses an opportunity for photography. Therefore, although inconvenient, the user has to cautiously check the settings of the camera before photographing so as to not make a mistake.

### SUMMARY

One or more embodiments of the invention include a photographing apparatus and a photographing method for photographing in an appropriate photographing mode with the user having to perform inconvenient operations. Also included is a non-transitory computer-readable medium having stored thereon a program for carrying out various embodiments of the photographing method.

Additional aspects will be set forth in part in the description which follows and, in part, will be apparent from the description, or may be learned by practice of the described embodiments.

According to one or more embodiments, a photographing apparatus includes a state determination unit that determines a state of a subject; a mode determination unit that determines a photographing mode according to the determined state of the subject; and a photography unit that carries out photography in the determined photographing mode.

The mode determination unit may determine the photographing mode as either a continuous shooting mode or a single shooting mode.

The photographing apparatus may also include a notification unit that notifies a user of the continuous shooting mode, when the mode determination unit determines the photographing mode is the continuous shooting mode.

The notification unit may notify the user of the continuous shooting mode before the start of photography in the continuous shooting mode.

The notification unit may notify the user of the continuous shooting mode before a shutter button is converted from a first state, in which the shutter button is half-pressed, to a second state, in which the shutter button is completely pressed.

The notification unit may display the number of images to be captured before the start of photography in the continuous shooting mode.

While the photography is being performed in the continuous shooting mode, the notification unit may continuously notify to the user that the photography is being performed in the continuous shooting mode.

After the shutter button is completely pressed, the notification unit may continuously notify that the photography is being performed in the continuous shooting mode until the photography in the continuous shooting mode is finished.

While photography is being performed in the continuous shooting mode, the notification unit may display a remaining number of images to be captured.

The notification unit may notify the user of the continuous shooting mode by using at least one of a display, audio output and vibration output.

The state determination unit may determine whether or not the subject is in a moving state.

The state determination unit may determine whether the subject is in a backlit state or a mixed light source state.

The mode determination unit may change the number of images to be captured according to the determined state of the subject.

The mode determination unit may change the number of images to be captured according to a moving speed of the subject.

The mode determination unit may determine the number of images to be captured set in the continuous shooting mode as a preset number of images to be captured.

According to one or more embodiments of the invention, a photographing method includes determining a state of a subject; determining a photographing mode according to the determined state of the subject; and performing photography in the determined photographing mode.

The photographing method may include notifying a user of the continuous shooting mode, when a mode determination unit of a photographing apparatus determines that the photographing mode is the continuous shooting mode.

Determining the state of the subject may include determining whether or not the subject is in a moving state.

Determining the photographing mode may involve changing the number of images to be captured according to the determined state of the subject.

According to one or more embodiments, a program for executing the previously-described photographing method is stored on a non-transitory computer-readable medium.

### BRIEF DESCRIPTION OF THE DRAWINGS

These and/or other aspects will become apparent and more readily appreciated from the following description of the embodiments, taken in conjunction with the accompanying drawings in which:

FIG. 1 is a block diagram illustrating a schematic structure of a photographing apparatus according to an embodiment;

FIG. 2 is a block diagram illustrating an example of a structure of an image process unit of the photographing apparatus according to an embodiment;

FIG. 3 is a view illustrating an example of images captured in a continuous shooting mode by the photographing apparatus according to an embodiment;

FIG. 4 is a flowchart of a photographing process executed in the photographing apparatus according to an embodiment;

FIG. 5 is a view illustrating an example of a screen (a first notification screen) showing a notification of the continuous shooting mode before photography is performed, according to an embodiment;

FIG. 6 is a view illustrating an example of a screen (a second notification screen) showing a notification of the continuous shooting mode while photographing, according to an embodiment; and

FIG. 7 is a view illustrating a modified example of the first and second notification screens, according to another embodiment.

### DETAILED DESCRIPTION

Reference will now be made in detail to various embodiments, examples of which are illustrated in the accompanying drawings, wherein like reference numerals refer to the like elements throughout. In this regard, the described embodiments may have different forms and should not be construed as being limited to the descriptions set forth herein. Accordingly, the figures are intended merely to help explain aspects of the described embodiments. Sizes and ratios of elements in the drawings may be different from the actual sizes and ratios. They may, for example, be exaggerated for convenience of explanation.

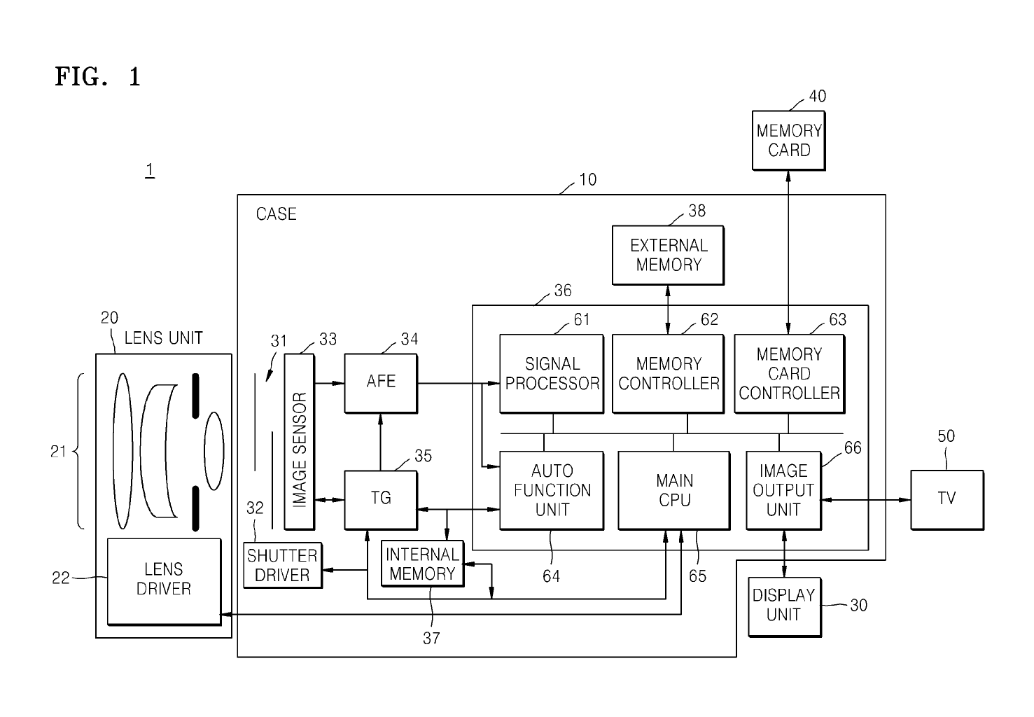

FIG. 1 is a block diagram illustrating a schematic structure of a photographing apparatus 1 according to an embodiment.

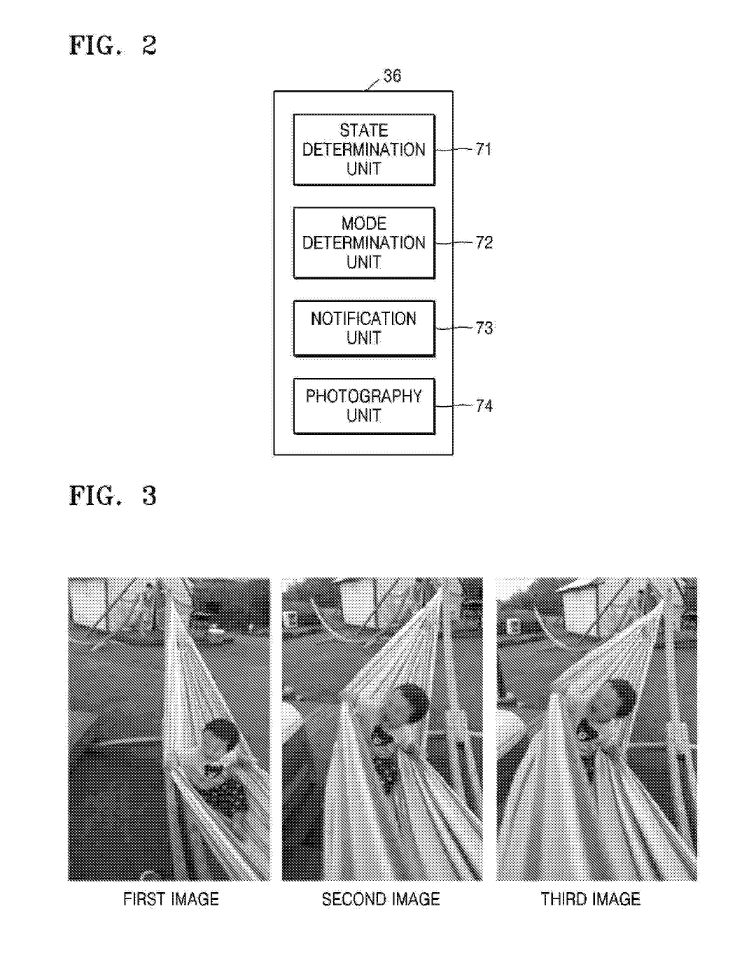

FIG. 2 is a block diagram illustrating an example of a structure of an image processor 36 of the photographing apparatus 1 according to an embodiment.

FIG. 3 is a view illustrating an example of images captured in a continuous shooting mode by the photographing apparatus 1 according to an embodiment.

Hereinafter, the photographing apparatus 1 will be described with reference to FIGS. 1 to 3.

The photographing apparatus 1 according to an embodiment includes one or more cameras, such as one or more digital cameras.

As illustrated in FIG. 1, the photographing apparatus 1 includes a case 10. Provided at a front side of the case 10 is a lens unit 20 for acquiring the image of a subject. A display unit 30, such as a liquid crystal display (LCD), is provided at a back side of the case 10.

The lens unit 20 includes an optical system 21 and a lens driver 22.

The optical system 21 includes a plurality of lenses, such as a zoom lens or a focus lens. The image of the subject may be enlarged or reduced by moving the zoom lens along an optical axis. Also, the image of the subject may be focused by moving the focus lens along the optical axis. In addition to the plurality of lenses, the optical system 21 may include an aperture for regulating an amount of transmitted light by adjusting an opening.

The lens driver 22 drives various lenses included in the optical system 21. The lens driver 22 may include drive motors such as a zoom motor that drives the zoom lens, a focus motor that drives the focus lens, or the like. Each motor may be a stepping motor or a direct current (DC) motor. Also, the lens driver 22 may include a central processing unit (CPU) for controlling various motors.

As illustrated in FIG. 1, the case 10 include a shutter 31, a shutter driver 32, an image sensor 33, an analogue front end (AFE) 34, a timing generator (TG) 35, an image processor 36, an internal memory 37, and an external memory 38.

The shutter 31 puts the image sensor 33 into either a light exposure state or a light shield state. The shutter driver 32 may be a stepping motor or a DC motor, and drives the shutter 31 according to a release signal.

The image sensor 33 may include a charge coupled device (CCD) or a complementary metal oxide semiconductor (CMOS). The image sensor 33 receives light that is concentrated by the lens unit 20 and executes photoelectric conversion to convert the light into an electric signal (an analogue signal). The AFE 34 processes, that is, amplifies (or gain-controls) the analogue signal, converts the analogue signal into a digital signal, and outputs the digital signal to the image processor 36. The AFE 34 may be an analogue amplifier or an analogue digital (A/D) converter. Also, the digital signal outputted from the AFE 34 is transmitted to a signal processor 61 and an auto function unit 64 in the image processor 36.

The TG 35 generates a timing pulse for driving the image sensor 33 and outputs the electric signal that is photoelectrically converted by the image sensor 33 to the image processor 36.

The image processor 36 controls the photographing apparatus 1. For example, as illustrated in FIG. 1, the image processor 36 includes the signal processor 61, a memory controller 62, a memory card controller 63, the auto function unit 64, a main CPU 65, and an image output unit 66. The elements described above may be mutually connected by buses for exchanging signals.

The signal processor 61 carries out various signal processes on the digital signal that is outputted from the AFE 34 and generates brightness data and color difference data that corresponds to a captured image. For example, the signal processor 61 may perform processes such as removing noise (a clamping process), detecting and correcting faulty pixels, generating 3 color data (R, G, and B data) for each pixel (a demosaicing process), improving color reproduction quality (a linear matrix), adjusting white balance, correcting contours of a main subject (a human, etc.), adjusting brightness (a gamma correction), converting the RGB data into YCbCr data (a YC conversion), and adjusting colors (a color difference correction).

The memory controller 62 inputs and outputs various data to and from the external memory 38. For example, the captured image (the brightness data and the color difference data) generated by the signal processor 61 may be stored in the external memory 38.

The memory card controller 63 inputs and outputs various data to and from a memory card 40. For example, the captured image (the brightness data and the color difference data) generated by the signal processor 61 may be stored in the memory card 40.

The auto function unit 64 moves the focus lens so as to increase high-frequency components in the center of the captured image (an auto focus function). Also, the auto function unit 64 controls the aperture or a shutter speed so as to acquire a light exposure amount corresponding to a brightness of the subject (an auto light exposure function). In addition, the auto function unit 64 adjusts the gain of each color signal in the AFE 34 so as to acquire an appropriate white balance corresponding to a color temperature of the subject (an auto white balance function).

The main CPU 65 is a control circuit including a processor for controlling the units described above or executing various operations according to programs. Functions of the image processor 36 are operated when respective programs are executed by the main CPU 65.

The image output unit 66 displays the captured image or a real-time observation image of the subject (that is, a live view image) on the display unit 30. Also, the image output unit 66 may transmit the captured image to a TV 50 that is communicably connected, and thus display the captured image on a monitor of the TV 50.

The internal memory 37 is a high-speed accessible main storage device for temporarily storing programs and data. The internal memory 37 is implemented as a semiconductor memory such as a flash memory and a random access memory (RAM) fixedly mounted in the photographing apparatus 1.

The external memory 38 is an auxiliary storage unit for storing various programs and data (including the captured image) executed by the main CPU 65. A flash memory may be used as the external memory 38.

The display unit 30 is formed of, for example, an LCD panel and displays the captured image, the live view image, and an image stored in the memory card 40. Also, the display unit 30 may display various setting screens, various messages for a user, and the like.

The memory card 40 is a portable memory for storing various images such as the captured image. The memory card 40 is not limited to a specific type of a memory card. As long as the memory card 40 is a portable memory such as a secure digital (SD) memory card, the memory card 40 may have any name, shape or structure.

As illustrated in FIG. 2, the image processor 36 of FIG. 1 includes a state determination unit 71, a mode determination unit 72, a notification unit 73, and a photography unit 74.

The state determination unit 71 determines a state of a subject. For example, the state determination unit 71 determines whether the subject is moving, that is, whether the subject is in a moving state. Also, the state determination unit 71 may determine whether the subject is in a backlit state or in a mixed light source state.

The moving state indicates that the main subject (such as a human, an animal, a vehicle, or a portion of scenery) is not staying in a single location in the live view image. The backlit state indicates that light from the sun is directly incident upon a lens (the optical system 21), the brightness of the scene in the live view image is high (bright) and the brightness of the main subject is low (dark). Also, the mixed light source state indicates that light from a plurality of light sources (such as sunlight and fluorescent light) are mixed, and that a plurality of peak wavelengths are included in a spectrum distribution acquired from the live view image.

The mode determination unit 72 determines whether or not to photograph in the continuous shooting mode (for acquiring a plurality of captured images), depending on the state of the subject. That is, a photographing mode of the photographing apparatus 1 may be determined depending on the state of the subject.

Specifically, the mode determination unit 72 determines the photographing mode to be the continuous shooting mode in situations where the user is likely to make a mistake in photography or miss photographing opportunities. For example, since the subject may be shaking when the subject is moving, the user is likely to miss a good shot. Thus, the mode determination unit 72 determines the photographing mode to be the continuous shooting mode. Also, when the subject is in the backlit state or the mixed light source state, since the user is not likely to be able to photograph in an appropriate photographing condition (a set value), the user may easily make a mistake in photography. Therefore, the mode determination unit 72 changes the photographing condition each time the photography is performed and determines the photographing mode to be the continuous shooting mode. When the mode determination unit 72 determines the photographing mode not to be the continuous shooting mode, the mode determination unit 72 determines the photographing mode to be the single shooting mode.

When the mode determination unit 72 determines the photographing mode to be the continuous shooting mode, the notification unit 73 notifies the user that the photography is to be performed in the continuous shooting mode. For example, the notification unit 73 displays the number of images to be captured in the continuous shooting mode on the display unit 30 (a first notification). Also, while photographing in the continuous shooting mode, the notification unit 73 displays a notification that the photography is being performed in the continuous shooting mode. For example, a remaining number of images to be captured is displayed on the display unit 30 (a second notification). The user may be notified not only by a notification on the display unit 30, but also by a sound or vibration.

The photography unit 74 captures the subject by controlling the units of the photographing apparatus 1 (such as the optical system 21, the shutter 31, the TG 35, the signal processor 61, and the auto function unit 6). For example, the photography unit 74 uses the image sensor 33 to capture the image of the subject that is formed by the optical system 21. Here, the image captured by the image sensor 33 is processed in the signal processor 61 and stored in a predetermined storage area (such as the external memory 38 and the memory card 40).

Also, the photography unit 74 captures the subject in the photographing mode determined by the mode determination unit 72.

For example, when the mode determination unit 72 determines the photographing mode to be the continuous shooting mode, the photography is performed in the continuous shooting mode as illustrated in FIG. 3. In FIG. 3, three images of the main subject (in FIG. 3, a child) moving on a hammock are captured in the continuous shooting mode. When the photography is performed in the continuous shooting mode, even if the subject is moving in 2 out of 3 images, the subject may be successfully captured in a remaining image. Thus, the user may easily obtain a successfully captured image. Also, since the most satisfactory image may be selected from among a plurality of captured images, the continuous shooting mode may be regarded as a mode in which a good shot will not be missed. On the other hand, when the mode determination unit 72 determines the photographing mode to be the single shooting mode, the photography unit 74 photographs in the single shooting mode.

Also, the photography unit 74 may use a live view image sensor (not shown) to capture a live view image and display the live view image on the display unit 66 by using the image output unit 66.

The state determination unit 71, the mode determination unit 72, the notification unit 73, and the photography unit 74 are implemented by using the main CPU 65 to read the programs that are installed in the external memory 38 into the internal memory 37 and execute the programs.

Hereinafter, operations of the photographing apparatus 1 will be described.

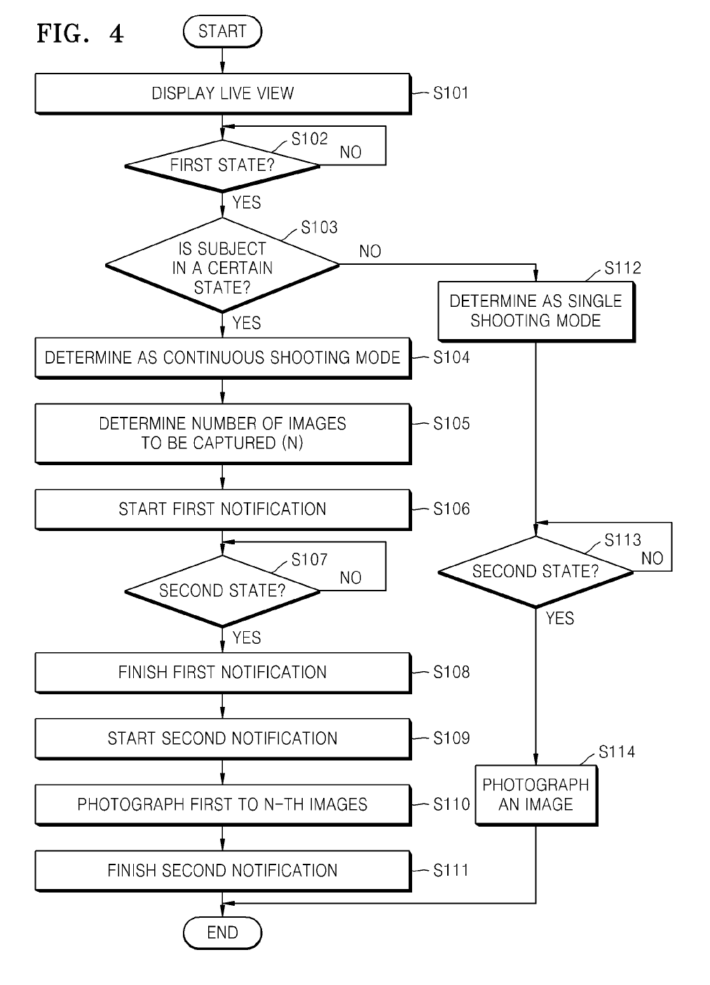

FIG. 4 is a flowchart of a photographing process executed in the photographing apparatus 1 according to an embodiment.

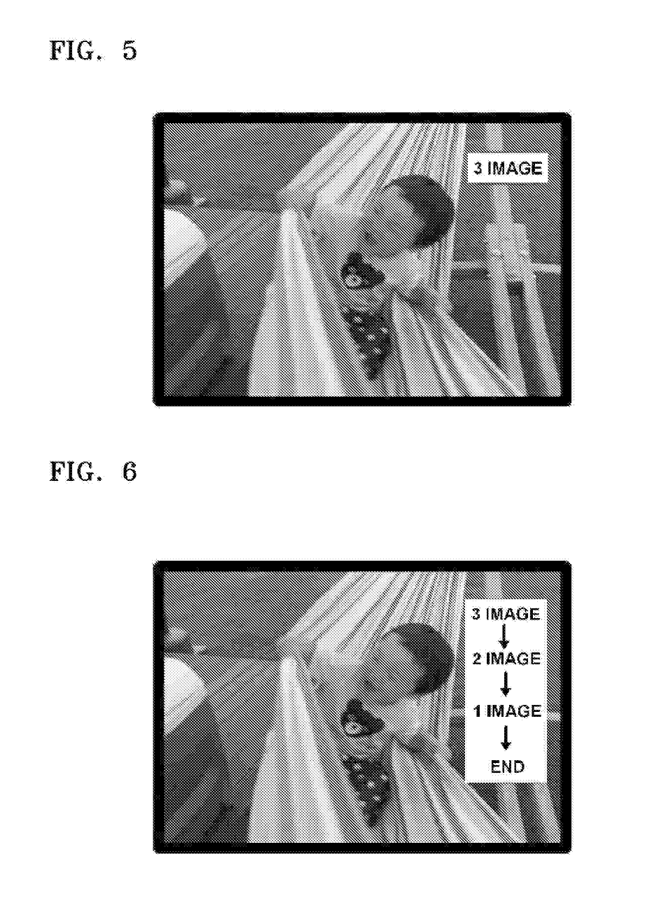

FIG. 5 is a view illustrating an example of a screen (a first notification screen) that displays a notification that the photography will be performed in the continuous shooting mode before photographing, according to an embodiment.

FIG. 6 is a view illustrating an example of a screen (a second notification screen) that displays a notification that the photography is being performed in the continuous shooting mode while photographing, according to an embodiment.

Hereinafter, a sequence of the photographing process will be described by referring to FIGS. 4 to 6.

For example, when power is supplied, the photographing apparatus 1 starts the photographing process of FIG. 4.

When the photographing process starts, the photography unit 74 displays the live view image on the display unit 30 (operation S101). Accordingly, the user may look at the display unit 30 and frame of the subject. The live view image is continuously displayed until the photographing process is finished.

Then, the photography unit 74 determines whether or not a shutter button (not shown) has been put into a first state (operation S102) by the user. For example, the photography unit 74 determines that the shutter button is in the first state when the shutter button is in a half-pressed state.

If the shutter button is not manipulated by the user and thus is not in the first state (operation S102: NO), the photographing apparatus 1 goes on standby until the shutter button is in the first state.

Then, when the shutter button goes into the first state (operation S102: YES), the state determination unit 71 of the photographing apparatus 1 determines the state of the subject (operation S103).

In operation S103, the photographing apparatus 1 determines whether or not the subject is in a certain state (the moving state, the backlit state, the mixed light source state, or the like). To determine whether the subject is in a moving state, the photographing apparatus 1 identifies the main subject (such as a human, an animal, a vehicle, or a portion of scenery) from various live view images acquired by the photography unit 74 by using an image identification method, and determines whether or not the main subject moves to another location when time elapses. For example, when the amount that the main subject moves is above a predetermined threshold value, the photographing apparatus 1 determines that the main subject has moved.

Also, in operation S103, the photographing apparatus 1 may determine whether or not the subject is in the backlit state. In this case, the photographing apparatus 1 identifies the main subject from a current live view image that is acquired by the photography unit 74 by using the image identification method, and determines whether or not the brightness of the main subject is lower (darker) than the brightness of the scenery.

In addition, in operation S103, the photographing apparatus 1 may determine whether or not the subject is in the mixed light source state. In this case, the photographing apparatus 1 investigates the spectrum distribution regarding the current live view image acquired by the photography unit 74, and determines whether or not the peak wavelengths exist in a plurality of locations.

When it is determined that the state of the subject is in a certain state (the moving state, the backlit state, the mixed light source state, or the like) by the methods describe above (operation S103: YES), the mode determination unit 72 of the photographing apparatus 1 determines the photographing mode to be the continuous shooting mode (operation S104).

When the photographing mode is determined to be the continuous shooting mode, the mode determination unit 72 of the photographing apparatus 1 determines the number of images to be captured in the continuous shooting mode (a photography number N) (operation S105). For example, the photographing apparatus 1 determines the photography number N as a preset number of images (3 images in the example illustrated in FIG. 1). The embodiment is not limited thereto, and the photographing apparatus 1 may change the photography number N depending on the state of the subject. For example, since the subject may be shaking when the subject is moving quickly, the photography number N may be increased; if the subject is moving slowly, the photography number N may be reduced.

Next, the notification unit 73 of the photographing apparatus 1 gives a notification that photography is to be performed in the continuous shooting mode before capturing the subject (the first notification) (operation S106). For example, as illustrated in FIG. 5, the photographing apparatus 1 may combine and display a message (an image) showing the photography number N determined in operation S105 on the live view image displayed on the display unit 30 (the first notification screen).

Then, the photography unit 74 of the photographing apparatus 1 determines whether the shutter button is in a second state by the user (operation S107). For example, the photographing apparatus 1 may determine that the shutter button is in the second state when the shutter button is in a completely pressed state. During operations S103 to S106, the shutter button is to be maintained in the first state by the user. If the shutter button is not being pressed during operations S103 to S106, the photographing process is forced to stop.

In operation S107, if the shutter button is maintained in the first state and not converted into the second state (operation S107: NO), the photographing apparatus 1 is on standby until the shutter button is converted into the second state.

If the shutter button is converted into the second state (operation S107: YES), the photographing apparatus 1 functions as the notification unit 73 and finishes the first notification that has been started in operation S106 (operation S108).

Also, the notification unit 73 of the photographing apparatus 1 issues a notification that the photography is being performed in the continuous shooting mode (the second notification) (operation S109). For example, as illustrated in FIG. 6, the photographing apparatus 1 may combine and display a message (an image) showing the remaining number of images to be captured (the number of photographing times) on the live view image displayed on the display unit 30 (the second notification screen).

Then, the photography unit 74 of the photographing apparatus 1 performs photography in the continuous shooting mode (operation S110). For example, the photographing apparatus 1 may control the shutter 31 and the TG 35 so as to acquire the photography number N of the captured images determined in operation S105. That is, the photographing apparatus 1 repeats a process of transmitting the captured images generated by the image sensor 33 to the image processor 36 N times with a certain interval. Each of the captured images generated by the image sensor 33 is stored in the memory card 40 via the signal processor 61.

According to another embodiment, the photographing apparatus 1 may change the photographing condition each time the photography is performed. For example, when the subject is in the backlit state, the photographing apparatus 1 changes a set value (such as a tone curve) of the signal processor 61, each time the photography is performed. Thus, the photographing apparatus 1 may acquire a plurality of captured images having different contrasts. Also, when the subject is in the mixed light source state, the photographing apparatus 1 controls the auto function unit 64 and changes the white balance whenever the photography is performed. Thus, the photographing apparatus 1 may acquire a plurality of captured images having different white balance values.

Until the photography in the continuous shooting mode described above is finished, the second notification that has been started in operation S109 may be continuously displayed.

In the example illustrated in FIG. 6, each time the photography is performed, the photographing apparatus 1 displays the remaining number of captured images by reducing the number one by one.

Then, when the photography number N times of photography is finished, the photographing apparatus 1 functions as the notification unit 73 and finishes the second notification (operation S111) and the photographing process.

In operation S103, if it is determined that the state of the subject is not in a certain state (the moving state, the backlit state, the mixed light source state, or the like) (operation S103: NO), the mode determination unit 72 of the photographing apparatus 1 determines the photographing mode to be the single shooting mode (operation S112).

Then, as in operation S107, the photography unit 74 of the photographing apparatus 1 determines whether or not the shutter button is in the second state by the user (operation S113).

If the shutter button is in the second state, (operation S113: YES), the photography unit 74 of the photographing apparatus 1 photographs in the single shooting mode (operation S114). For example, the photographing apparatus 1 controls the shutter 31 or the TG 35 so as to acquire a single captured image, and transmits the captured image generated by the image sensor 33 to the image processor 36. Then, the captured image is stored in the memory card 40 via the signal processor 61.

Then, the photographing apparatus 1 finishes the photographing process.

By executing the photographing process described above, the photographing apparatus 1 selects an appropriate photographing mode depending on the state of the subject. For example, photography may be automatically performed in the continuous shooting mode in situations where it is likely to make a mistake or miss photographing opportunities.

In addition, the photographing apparatus 1 according to an embodiment provides the first notification until the shutter button is converted from the half-pressed state (the first state) to the completely pressed state (the second state), that is, before starting the photography in the continuous shooting mode. Thus, the user may know in advance that the photography will be performed in the continuous shooting mode. Therefore, the user may be prevented from determining that the photographing mode is in the single shooting mode without knowing that the photographing apparatus 1 has determined otherwise and has automatically started the continuous shooting mode, and thus not be able to capture the main subject by using the photographing apparatus 1. As a result, the user may not turn the photographing apparatus 1 to a direction in which the main subject does not exist.

The photographing apparatus 1 according to an embodiment provides the second notification from the time the shutter button is in the completely pressed state (the second state) until photography in the continuous shooting mode is finished. Therefore, the user may easily know whether or not photography in the continuous shooting mode is finished. Thus, the user may be prevented from not knowing that photography in the continuous shooting mode is not finished and moving the photographing apparatus 1 away from the main subject.

The operations of the flowchart are divided according to a main purpose of an operation, so as to facilitate understanding of the photographing apparatus 1. The operations may be divided and named in other ways. The operations that are executed in the photographing apparatus 1 may be divided into more processes. Also, more processes may be executed in one operation.

The one or more embodiments described above are intended to exemplify the main concepts of the described herein, and are not intended to be limiting. It will be understood by those of ordinary skill in the art that various substitutions, amendments, or modifications may be made to one or more embodiments without departing from their spirit and scope.

For example, in the embodiment described above, as in the first notification screen illustrated in FIG. 5, the photographing apparatus 1 displays the photography number N in the continuous shooting mode on the display unit 30. Also, in the embodiment described above, as in the second notification screen illustrated in FIG. 6, the photographing apparatus 1 displays the remaining number of images to be captured in the continuous shooting mode on the display unit 30. However, the embodiments are not limited to the first and second notification screens respectively illustrated in FIGS. 5 and 6, and may use a different display method.

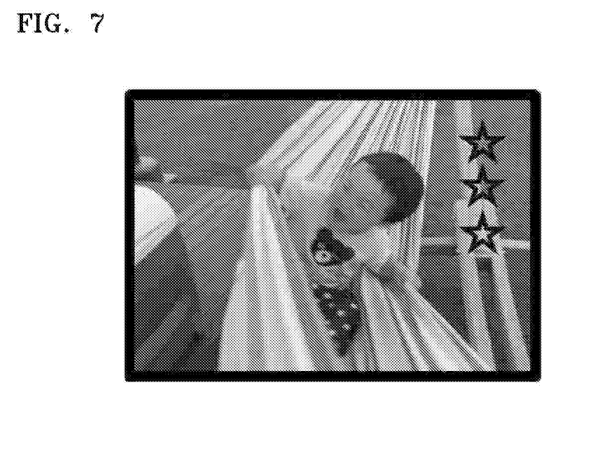

FIG. 7 is a view illustrating a modified example of the first and second notification screens, according to another embodiment. For example, as illustrated in FIG. 7, the photographing apparatus 1 according to another embodiment may display the photography number N of marks (such as a star-shaped mark) on the first notification screen. Also, the photographing apparatus 1 may reduce and display the number of marks illustrated in FIG. 7 on the second notification screen each time the photography is performed.

Each time the photography is performed, the photographing apparatus 1 according to another embodiment may change a color, a font, or a size of a message (image) showing the remaining number of captured images displayed on the second notification screen.

Only the main elements of the configuration of the photographing apparatus 1 are described above. However, the configuration of the photographing apparatus 1 is not limited thereto, and a general configuration of the photographing apparatus 1 is not excluded from the spirit and scope of this disclosure.

The elements of the image processor 36 are classified according to a main feature of an element, so as to facilitate the understanding of features of the elements. A method of classifying and naming the elements are not limited thereto. The elements may be classified into relatively more number of elements, according to features of each element. Also, the elements may be classified so that one element may execute more than one process.

A program for operating the photographing apparatus 1 may be provided in a computer-readable recording medium, such as a USB memory, a Floppy (registered trademark) disc, or a CD-ROM, or provided online via a network such as the Internet. In this case, a program recorded in a computer-readable recording medium is generally transferred to and stored in the external memory 38. Also, the program may be provided as independent application software, or be embedded in software of the photographing apparatus 1 as a feature thereof

The operations executed by the main CPU 65 may be implemented via an exclusive hardware circuit. In this case, the operations may be executed by hardware or a plurality of hardware.

As described above, according to one or more embodiments, it may be determined whether or not to perform photography in a continuous shooting mode depending on a state of a subject. Therefore, the photography may be automatically performed in the continuous shooting mode in situations where a user is likely to make a mistake or miss photographing opportunities. As a result, the user may appropriately photograph in a single shooting mode or the continuous shooting mode, without the inconvenience of having to cautiously identify settings before the photography.

It should be understood that the exemplary embodiments described therein should be considered in a descriptive sense only and not for purposes of limitation. Descriptions of features or aspects within each embodiment should typically be considered as available for other similar features or aspects in other embodiments.

While one or more embodiments of the have been described with reference to the figures, it will be understood by those of ordinary skill in the art that various changes in form and details may be made therein without departing from their spirit and scope of as defined by the following claims.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the embodiments illustrated in the drawings, and specific language has been used to describe these embodiments. However, no limitation of the scope of the invention is intended by this specific language, and the invention should be construed to encompass all embodiments that would normally occur to one of ordinary skill in the art. The terminology used herein is for the purpose of describing the particular embodiments and is not intended to be limiting of exemplary embodiments of the invention. In the description of the embodiments, certain detailed explanations of related art are omitted when it is deemed that they may unnecessarily obscure the essence of the invention.

The apparatus described herein may comprise a processor, a memory for storing program data to be executed by the processor, a permanent storage such as a disk drive, a communications port for handling communications with external devices, and user interface devices, including a display, touch panel, keys, buttons, etc. When software modules are involved, these software modules may be stored as program instructions or computer readable code executable by the processor on a non-transitory computer-readable media such as magnetic storage media (e.g., magnetic tapes, hard disks, floppy disks), optical recording media (e.g., CD-ROMs, Digital Versatile Discs (DVDs), etc.), and solid state memory (e.g., random-access memory (RAM), read-only memory (ROM), static random-access memory (SRAM), electrically erasable programmable read-only memory (EEPROM), flash memory, thumb drives, etc.). The computer readable recording media may also be distributed over network coupled computer systems so that the computer readable code is stored and executed in a distributed fashion. This computer readable recording media may be read by the computer, stored in the memory, and executed by the processor.

Also, using the disclosure herein, programmers of ordinary skill in the art to which the invention pertains may easily implement functional programs, codes, and code segments for making and using the invention.

The invention may be described in terms of functional block components and various processing steps. Such functional blocks may be realized by any number of hardware and/or software components configured to perform the specified functions. For example, the invention may employ various integrated circuit components, e.g., memory elements, processing elements, logic elements, look-up tables, and the like, which may carry out a variety of functions under the control of one or more microprocessors or other control devices. Similarly, where the elements of the invention are implemented using software programming or software elements, the invention may be implemented with any programming or scripting language such as C, C++, JAVA®, assembler, or the like, with the various algorithms being implemented with any combination of data structures, objects, processes, routines or other programming elements. Functional aspects may be implemented in algorithms that execute on one or more processors. Furthermore, the invention may employ any number of conventional techniques for electronics configuration, signal processing and/or control, data processing and the like. Finally, the steps of all methods described herein may be performed in any suitable order unless otherwise indicated herein or otherwise clearly contradicted by context.

For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. The words “mechanism”, “element”, “unit”, “structure”, “means”, and “construction” are used broadly and are not limited to mechanical or physical embodiments, but may include software routines in conjunction with processors, etc.

The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those of ordinary skill in this art without departing from the spirit and scope of the invention as defined by the following claims. Therefore, the scope of the invention is defined not by the detailed description of the invention but by the following claims, and all differences within the scope will be construed as being included in the invention.

No item or component is essential to the practice of the invention unless the element is specifically described as “essential” or “critical”. It will also be recognized that the terms “comprises,” “comprising,” “includes,” “including,” “has,” and “having,” as used herein, are specifically intended to be read as open-ended terms of art. The use of the terms “a” and “an” and “the” and similar referents in the context of describing the invention (especially in the context of the following claims) are to be construed to cover both the singular and the plural, unless the context clearly indicates otherwise. In addition, it should be understood that although the terms “first,” “second,” etc. may be used herein to describe various elements, these elements should not be limited by these terms, which are only used to distinguish one element from another. Furthermore, recitation of ranges of values herein are merely intended to serve as a shorthand method of referring individually to each separate value falling within the range, unless otherwise indicated herein, and each separate value is incorporated into the specification as if it were individually recited herein.

What is claimed is:

1. A photographing apparatus comprising:
a state determination unit that determines a state of a subject;
a mode determination unit that determines a photographing mode according to the determined state of the subject; and
a photography unit that carries out photography in the determined photographing mode.

2. The photographing apparatus of claim 1, wherein the mode determination unit determines the photographing mode as either a continuous shooting mode or a single shooting mode.

3. The photographing apparatus of claim 1, further comprising a notification unit that notifies a user of the continuous shooting mode, when the mode determination unit determines that the photographing mode is the continuous shooting mode.

4. The photographing apparatus of claim 3, wherein the notification unit notifies the user of the continuous shooting mode before the start of photography in the continuous shooting mode.

5. The photographing apparatus of claim 3, wherein the notification unit notifies the user of the continuous shooting mode before a shutter button of the photographing apparatus moves from a first state, in which the shutter button is half-pressed, to a second state, in which the shutter button is completely pressed.

6. The photographing apparatus of claim 3, wherein the notification unit displays the number of images to be captured before starting to perform photography in the continuous shooting mode.

7. The photographing apparatus of claim 3, wherein while the photography is being performed in the continuous shooting mode, the notification unit continuously notifies the user of the continuous shooting mode.

8. The photographing apparatus of claim 3, wherein after the shutter button is completely pressed, the notification unit continuously notifies the user of the continuous shooting mode until the photography in the continuous shooting mode is finished.

9. The photographing apparatus of claim 3, wherein while photography is being performed in the continuous shooting mode, the notification unit displays a remaining number of images to be captured.

10. The photographing apparatus of claim 3, wherein the notification unit notifies the user of the continuous shooting mode by using at least one of a display, audio output, and vibration output.

11. The photographing apparatus of claim 1, wherein the state determination unit determines whether or not the subject is in a moving state.

12. The photographing apparatus of claim 1, wherein the state determination unit determines whether the subject is in a backlit state or a mixed light source state.

13. The photographing apparatus of claim 1, wherein the mode determination unit changes the number of images to be captured according to the determined state of the subject.

14. The photographing apparatus of claim 13, wherein the mode determination unit changes the number of images to be captured according to a moving speed of the subject.

15. The photographing apparatus of claim 1, wherein the mode determination unit determines the number of images to be captured set in the continuous shooting mode as a preset number of images to be captured.

16. A photographing method comprising:
determining a state of a subject;
determining a photographing mode according to the determined state of the subject; and
performing photography in the determined photographing mode.

17. The photographing method of claim 16, further comprising notifying a user of the continuous shooting mode, when the mode determination unit determines that the photographing mode is the continuous shooting mode.

18. The photographing method of claim 16, wherein the state determining comprises determining whether or not the subject is in a moving state.

19. The photographing method of claim 16, wherein the mode determining, comprises changing the number of images to be captured according to the determined state of the subject.

20. A non-transitory computer-readable recording medium having stored thereon a program for executing the method of claim 16.
